(19) United States
(12) Patent Application Publication
(10) Pub. No.: US 2016/0332739 A1
(43) Pub. Date: Nov. 17, 2016

(54) IMPACT ABSORPTION APPARATUS FOR UNMANNED AERIAL VEHICLE

(71) Applicant: Disney Enterprises, Inc., Burbank, CA (US)

(72) Inventor: Clifford Wong, Burbank, CA (US)

(21) Appl. No.: 14/713,343

(22) Filed: May 15, 2015

(51) Int. Cl. B64D 25/00; B64C 39/02

(52) U.S. Cl. CPC B64D 25/00; B64C 39/024; B64C 2201/024; B64C 2201/14

(57) ABSTRACT

An unmanned aerial vehicle apparatus comprises a frame. Further, the unmanned aerial vehicle apparatus comprises a propulsion mechanism coupled to the frame that propels the frame through the air. In addition, the unmanned aerial vehicle apparatus comprises a storage device that stores one or more airbags and is coupled to the frame. The unmanned aerial vehicle apparatus also comprises an inflation device coupled to the frame that receives an activation signal and inflates the one or more airbags based upon receipt of the activation signal to deploy the one or more airbags from the storage device prior to an impact of the frame with an object.

### BACKGROUND

1. Field

This disclosure generally relates to the field of aerial vehicles. More particularly, the disclosure relates to safety mechanisms for aerial vehicles.

2. General Background

Unmanned aerial vehicles (“UAVs”) such as flying robots, drones, airplanes, helicopters, multicopters, e.g., flying robots that operate in a manner similar to helicopters with multiple propellers, balloons, etc. have become more commonplace in entertainment environments such as theme parks, film sets, sports environments, and news environments. A pilot can wirelessly navigate the UAV from a remote location. Alternatively, the UAV may have an autopilot feature so that it is operated and navigated by a computing device. A human is not present on the UAV during flight of the UAV. UAVs have been used for providing entertainment, aerial cinematography, gathering video, images, and/or audio, etc.

As UAVs increasingly fly over locations where people are present, safety for those people is an important goal. Equipment malfunction, aerial hazards, and aerial maneuvers are examples of events which may result in a loss of propulsion.

A previous solution was to attach a parachute to the UAV. The parachute could be ejected via a wireless instruction sent by a pilot or a computing device that operated the UAV or by on-board monitoring systems. A problem with using a parachute is that the parachute can get tangled with propulsion units of the UAV during or after ejection of the parachute. Typical UAVs, e.g. multicopters, are devices that are naturally unstable, hence malfunctions can result in a tumbling vehicle. For example, a multicopter can flip during ejection of the parachute. The parachute could then get entangled with the propulsion units of the multicopter during the flip and not eject properly or not provide much help in decelerating the multicopter if the parachute is ejected. Further, a parachute is often fabricated from a heavy material that significantly slows normal movement. Moreover, a parachute requires a fall distance to deploy and properly decelerate a vehicle. Therefore, a parachute is less effective at low altitude. As a result, a continuing need exists for robust UAV safety systems that do not impede normal operation and that perform well at low altitudes.

Another solution was the establishment of a geofence. The geofence allows the UAV to fly within a perimeter, e.g., a safe distance away from people or objects. Geofencing restricts the use and benefits of a UAV. Since a geofence is a control system rather than a physical barrier, the UAV can still fly through the geofence as a result of hardware or logic failure.

There is a continuous need to improve safety performance of UAVs.

### SUMMARY

An unmanned aerial vehicle apparatus comprises a frame and a propulsion mechanism coupled to the frame that propels the frame through the air. A storage device stores one or more airbags and is coupled to the frame. An inflation device coupled to the frame receives an activation signal and in response inflates the one or more airbags prior to an impact of the frame with an object.

A method comprises propelling an unmanned aerial vehicle through the air. An activation signal is sent to an inflation device that inflates one or more airbags coupled to the aerial vehicle to deploy the one or more airbags from the storage device.

A system comprises a sensor that determines a condition of a component of an unmanned aerial vehicle. The unmanned aerial vehicle has one or more airbags and an inflation device. Further, the system comprises a processor that receives a signal from the sensor indicative of the condition of the component and sends an activation signal to the inflation device to deploy the one or more airbags from the storage device prior to an impact of the unmanned aerial vehicle with an object.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a UAV system.

FIGS. 2A, 2B, and 2C illustrate a front view, a side view, and a perspective view of the components of the UAV apparatus illustrated in FIG. 1.

FIGS. 3A and 3B illustrate an example of the UAV apparatus illustrated in FIGS. 2A, 2B, and 2C partially deploying and fully deploying a first airbag and a second airbag.

FIG. 4 illustrates the internal electronic components of the electronic control device illustrated in FIGS. 2A, 2B, and 2C.

### DETAILED DESCRIPTION

A UAV comprising an impact absorption device is provided to improve safety in close proximity to a flying UAV. The impact absorption device is inflated by the UAV after detection of a condition that may lead to a ground impact, but prior to that impact. The inflated impact absorption device covers the hard, sharp, and spinning parts of the UAV, e.g., the propellers, the frame, etc. As a result, any impact of the UAV is with an inflated object rather than a hard or spinning UAV component. The impact absorption device is configured to prioritize reducing the effect of impact as opposed to preventing damage to the UAV.

As an example, the impact absorption device comprises one or more airbags that are each activated by one or more components of the UAV after the UAV detects a condition warranting activation. Such conditions include power failure, motor failure, guidance system failure, unexpected change in control source, navigation failure, air pressure change, change in acceleration or speed, mid-air collision with an obstacle and the like. For instance, a first airbag is positioned above the center of gravity of the UAV whereas a second airbag is positioned below the center of gravity of the UAV. Each airbag has dimensions such that both in total engulf the entire frame structure and propulsion mechanism, e.g., propellers, of the UAV. In contrast with previous approaches, e.g., the parachute configuration, that allowed different components of the UAV to be exposed after the safety mechanism was activated, the UAV uses the impact absorption device to engulf the hard, sharp and spinning components of the UAV to reduce the effect of impact.

The impact absorption device also helps slow the acceleration of the UAV during free fall. For instance, the UAV engulfed in two airbags will have significantly greater air resistance and so fall at a much slower velocity and acceleration than the UAV without two airbags. The resulting slower descent lowers the force of impact arising from contact with objects or the ground.

The impact absorption device is configured to lessen effects on flight performance in contrast with previous approaches, e.g., the parachute configuration, that used heavy materials that affected flight performance of a UAV. For example, each airbag can weigh less than one hundred grams. The airbag can be fabricated from an ultra lightweight film rather than a durable and puncture-proof material commonly used for parachutes. Therefore, the UAV can fly at similar speeds and perform similar maneuvers with the impact absorption device as if the UAV did not have the impact absorption device.

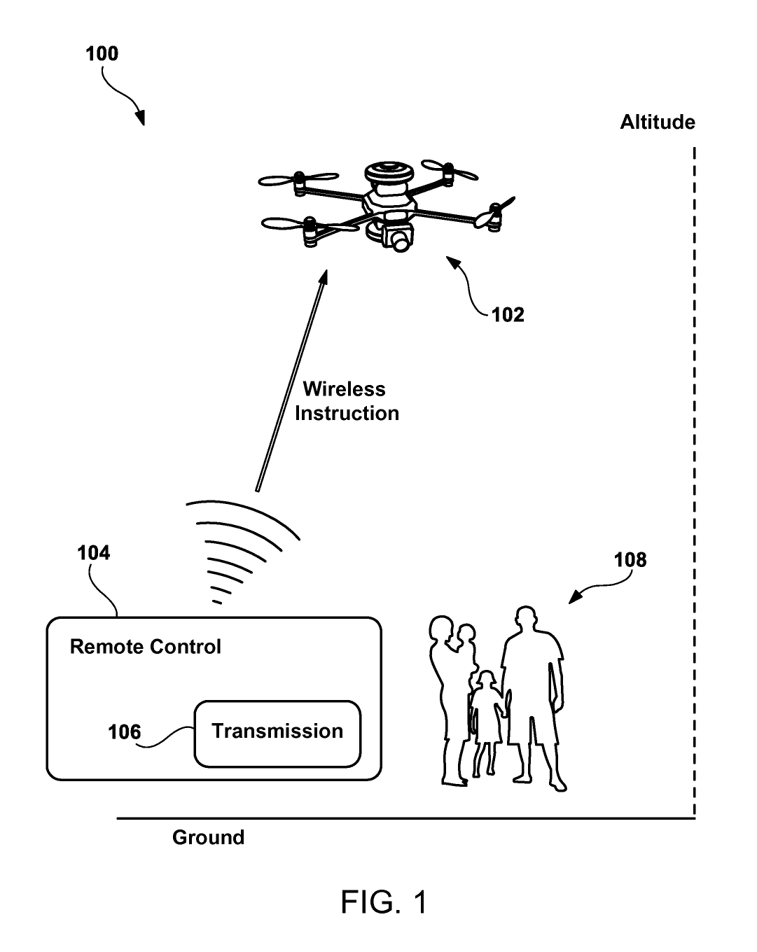

FIG. 1 illustrates a UAV system 100. The UAV system 100 comprises a UAV 102, e.g., a flying robot, drone, unmanned airplane, unmanned helicopter, unmanned multicopter, unmanned balloon, and a remote control 104 having a transmitter 106. The UAV 102 flies autonomously or with remote human navigation above one or more people 108 and/or a plurality of objects (not shown). The remote control 104 is a wireless device that radiates Radio Frequency (“RF”), audio, or an optical signal to activate the impact absorption device. The signal can be generated by a human operator or autonomously via a computing device. The computing device can be an onboard device that executes instructions for the UAV. Alternatively, the computing device can be a remote land-based device that sends remote instructions to the UAV from an operator. The computing device can also be present onboard a neighboring or remotely situated distinct UAV. The instructions can go to a particular location in 3D space. If the UAV 102 flies autonomously, the UAV system 100 may operate without the remote control 104.

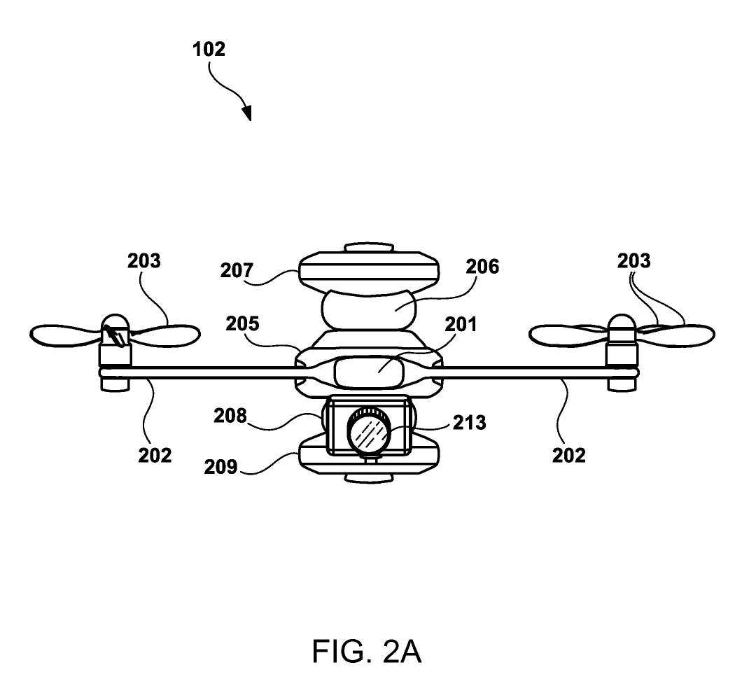

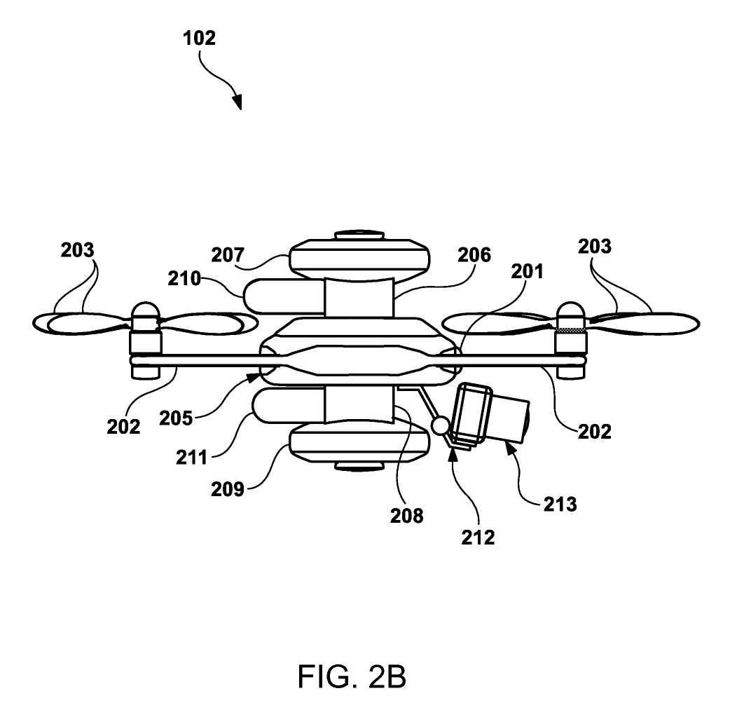

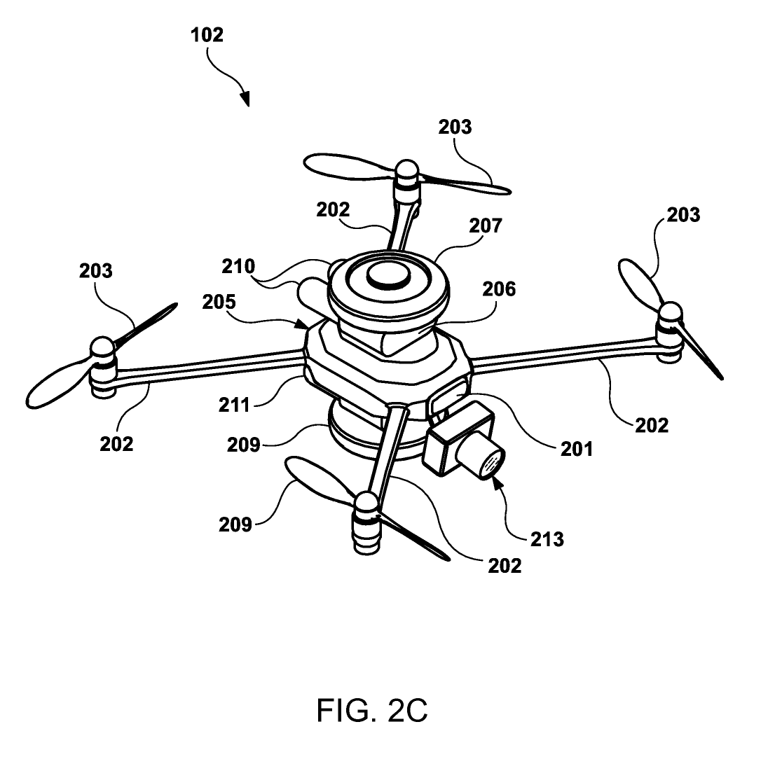

FIGS. 2A, 2B, and 2C illustrate a front view, a side view, and a perspective view of the components of the UAV apparatus 102 illustrated in FIG. 1. The UAV apparatus 102 has a frame 205, a plurality of connectors 206 and 208, a plurality of storage devices 207 and 209, and a plurality of inflation devices 210 and 211. The connectors 206 and 208 can be platforms, chambers, arms, cages, or other types of mounting devices, that are used to connect the plurality of storage devices 207 and 209 to the frame 205. The first storage device 207 is operably attached to the first inflation device 210. Further, the second storage device 209 is operably attached to the second inflation device 211.

The inflation devices 210 and 211 can be canisters of a compressed gas such as carbon dioxide. The inflation devices 210 and 211 are used to inflate impact absorption devices such as an airbag stored in the first storage device 207 and an airbag stored in the second storage device 209. Although the inflation devices 210 and 211 are illustrated as being positioned within the connectors 206 and 208, e.g., chambers, the inflation devices 210 and 211 can be situated on the top or sides of the storage devices 207 and 209. Alternatively, the inflation devices 210 and 211 can be positioned on the connectors 206 and 208 in proximity to the first storage device 207 and the second storage device 209. In addition, the first inflation devices 210 and 211 can take the form of a variety of different shapes and sizes. The inflation devices 210 and 211 can also be integrated within the first storage device 207 and the second storage device 209.

The frame 205 also has the components of the UAV that are used to perform flight operation of the UAV. For instance, the frame 205 has a control device 201 that has the components for performing flight operation either autonomously or based upon an instruction received from the remote control 104. The control device 201 also has sensors for detecting a UAV malfunction or other event in which the airbag should be deployed and one or more electromechanical actuators, e.g., valves, for activating the impact absorption device.

The frame 205 also has a plurality of arms 202 that are each operably connected to a propulsion mechanism 203, e.g., a propeller mounted on a motor, where the motor is coupled to control device 201. Control device 201 varies the speed of each of the propulsion devices 203 so as to control altitude and travel direction of UAV 102. Other implementations may be operated with one propeller, e.g., a helicopter, or without any propellers, e.g., a balloon.

Further, a mounting device 212 may be used to mount various components to the frame 205. For example, an image capture device 213 may be mounted to the frame 205. The image capture device 213 may perform image capture during flight to allow a remotely positioned human pilot to navigate the UAV 102.

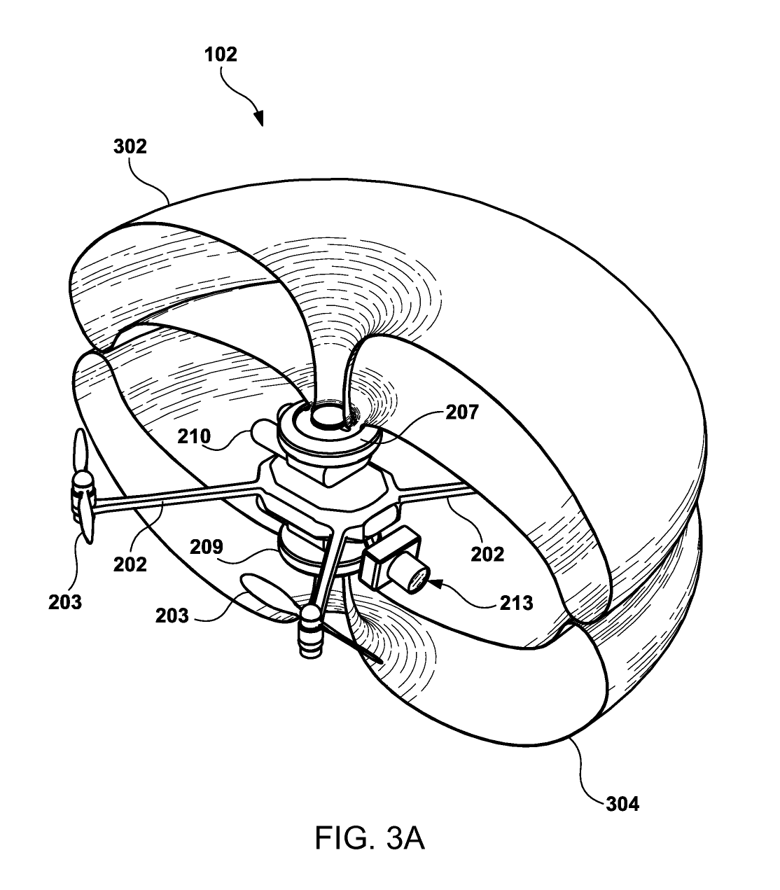

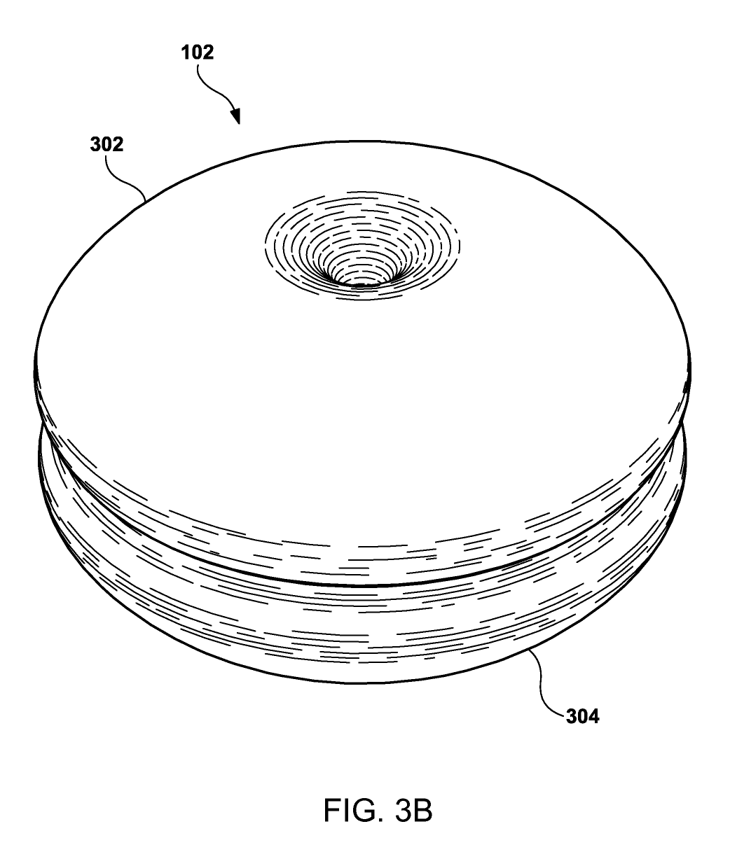

FIGS. 3A and 3B illustrate an example of the UAV apparatus 102 illustrated in FIGS. 2A, 2B, and 2C partially deploying and fully deploying a first airbag and a second airbag. The first airbag 302 is deployed from the first storage device 207 by the first inflation device 210 whereas the second airbag 304 is deployed from the second storage device 209 by the second inflation device 211. The first airbag 302 has dimensions such that the first airbag 302 covers the propellers 203 attached to the frame 205, the first storage device 207, and a significant portion of the electronic control device 201. Further, the second airbag 304 has dimensions such that the second airbag 304 covers the second storage device 209, the mounting device 212, the image capture device 213, and a significant portion of the electronic control device 201. The first airbag 302 and the second airbag 304 cover all of the propellers 203, electronic components, and any other components that are part of or are attached to the frame 205 that may present hard, sharp or spinning components during free fall or impact. The airbags 302 and 304 together form a balloon-like structure. As the balloon-like structure is inflated it has a solid shape that absorbs large forces associated with rapid deceleration of UAV 102 upon impact. The inflation can be performed at various speeds, e.g., instantaneously, slowly, etc.

Although two inflation devices 210 and 211 are illustrated, a single inflation device may be used to inflate multiple airbags such as airbags 302 and 304. For instance, a single inflation device, e.g., a valve, may be electromechanically operated by the electronic control device 201 to rotate to different storage devices 207 and 209 to inflate airbags 302 and 304.

Further, a single airbag may be used if a portion of the UAV 102 has a soft payload. For instance, a UAV 102 that has a bottom portion with a soft material may only need a single airbag to cover an upper portion having sharp and other components that pose safety hazards. In addition, more than two airbags may be used to cover a UAV apparatus 102. For example, a large UAV 102 may have many components that necessitate use of more than two airbags.

In one implementation, the airbags 302 and 304 are sealed. In other words, the airbags 302 and 304 do not release air upon impact unless there are punctures of the airbags 302 and 304. In another implementation, the airbags 302 and 304 have vents that release air from the airbags 302 and 304 upon impact. The release of air upon impact helps further reduce forces resulting from impact.

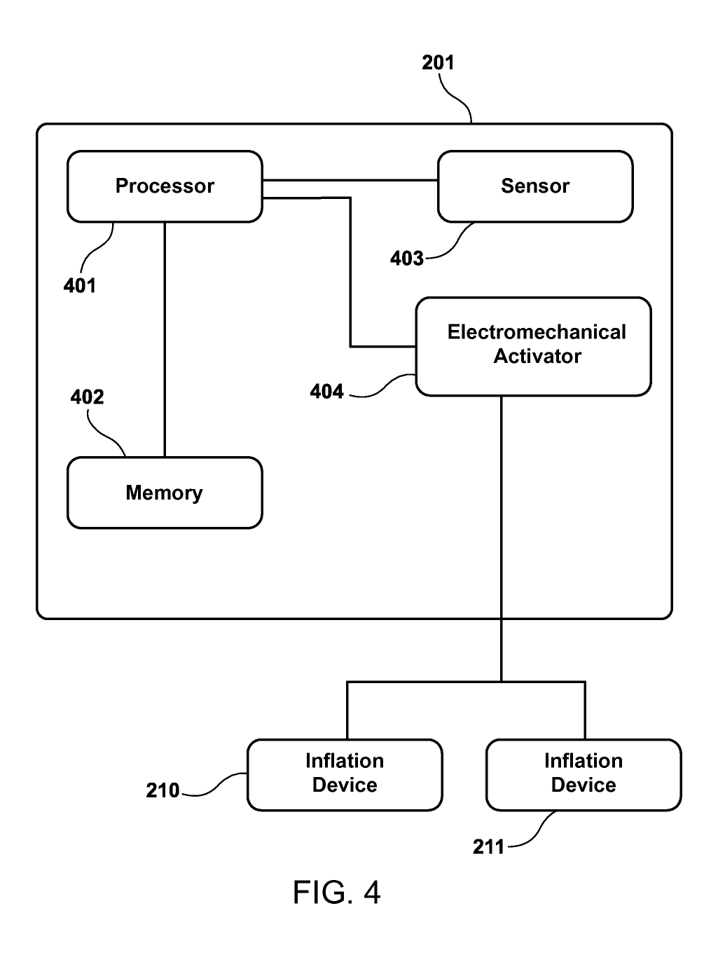

FIG. 4 illustrates the internal components of the control device 201 illustrated in FIGS. 2A, 2B, and 2C. The electronic control device 201 comprises a processor 401, a memory 402, a sensor 403, and an activator 404. The sensor(s) 403, e.g., accelerometer, altimeter, gyroscope, etc., provides data, e.g., an activation signal, to the processor 401 so that the processor 401 can determine if the UAV apparatus 102 has malfunctioned or otherwise experienced an event that warrants deploying airbags.

A variety of different sensors 403 can be used to trigger an activation signal, which removes power from the propulsion devices, e.g., propellers 203 and/or activates the electromechanical activator 404. The sensors 403 can detect the malfunction based on simplified logic criteria, i.e., sense a flip, a broken propeller, bad battery, electronic health failure, communication failure, or software failure.

As an example, the sensor 403 is an accelerometer that provides acceleration data to the processor 401 for storage in the memory 402. Alternatively, the acceleration data can be stored in one or more registers of the processor 401. The processor 401 then determines that the UAV apparatus 102 is accelerating faster than a predetermined acceleration. The processor 401 then determines that airbags 302 and 304 illustrated in FIGS. 3A and 3B should be deployed. The processor 401 sends an activation signal to the electromechanical activator 404 instructing the electromechanical activator 404 to activate inflation devices 210 and 211. The inflation devices 210 and 211 then deploy airbags 302 and 304 from the first storage device 207 and the second storage device 209.

As another example, the sensor 403 is an altimeter that determines altitude data for the UAV apparatus 102. The processor 401 then determines that the UAV apparatus 102 is flying at an altitude that is less than a predetermined altitude. The processor 401 then determines that airbags 302 and 304 illustrated in FIGS. 3A and 3B should be deployed.

As yet another example, the sensor 403 is a gyroscope that determines pitch, roll, and/or yaw data. The gyroscope provides that data to the processor 401, which can determine if the UAV is performing any unexpected rotations. As an example, the gyroscope sends the processor 401 data that indicates that the UAV had a pitch and roll each greater than seventy degrees. The processor 401 determines that such a rotation is a flip that was unexpected.

As another example, the sensor 403 is a current sensing sensor that determines if a motor (not shown) is consuming current. If the sensor 403 determines that the motor is not consuming any current or is consuming an abnormally high amount of current, the sensor 403 provides that data to the processor 401, which may determine that a motor failure has occurred.

The sensor 403 may also be a component sensor, i.e., a sensor that determines that a component has malfunctioned. For instance, the sensor 403 may determine that a propeller 203 is not functioning properly. The sensor 403 sends the data to the processor 401 so that the processor 401 can determine if airbag deployment is necessary based upon whether or not the sensor data is within an acceptable threshold or range. The sensor 403 can also determine if a communication failure has occurred with a particular component.

The processor 404 is not necessary for operation of the sensor 403. For example, a component attached to the sensor 403 can be configured to operate only if the sensor 403 provides a signal having a value in a certain range. For instance, the inflation devices 210 and 211 illustrated in FIGS. 2A, 2B, and 2C may be operably attached to a sensor that detects if the motor is not consuming any current or is consuming an abnormally high amount of current. The inflation devices 210 and 211 are configured to be activated to inflate airbags if the sensor 403 does not provide any signal indicating current consumption or provides a signal of an abnormally high level of current.

1. A unmanned aerial vehicle comprising:
a frame;
a propulsion mechanism coupled to the frame that propels the frame through the air;
one or more airbags coupled to the frame; and
an inflation device coupled to the frame and to at least one of the one or more airbags, wherein the inflation device inflates the one or more airbags based upon receipt of an activation signal such that the one or more airbags engulf the frame and the propulsion mechanism.

2. The unmanned aerial vehicle of claim 1, wherein the inflation device comprises a canister of carbon dioxide having an electromechanical activator.

3. The unmanned aerial vehicle of claim 1, wherein the one or more airbags have inflated dimensions such that the frame and the propulsion mechanism are engulfed after inflation of the one or more airbags.

4. The unmanned aerial vehicle of claim 1, further comprising a sensor that detects a component malfunction and sends the activation signal to the inflation device upon the detection of the component malfunction.

5. The unmanned aerial vehicle of claim 1, further comprising an altimeter producing an altitude signal; and
a processor coupled to receive the altitude signal, the processor executing code configured to determine whether the frame experiences a change in altitude, the processor sending the activation signal to the inflation device upon the processor determining that the frame is flying outside of an altitude range.

6. The unmanned aerial vehicle of claim 1, further comprising an accelerometer producing an acceleration signal or loss of signal; and
a processor coupled to receive the acceleration signal, the processor executing code configured to determine whether the frame experiences a change in acceleration , the processor sending the activation signal to the inflation device upon the processor determining that the frame is accelerating at an acceleration in excess of a predetermined acceleration.

7. The unmanned aerial vehicle apparatus of claim 1, further comprising a receiver that receives an instruction from a pilot remotely positioned from the unmanned aerial vehicle and sends the activation signal to the inflation device based upon the instruction.

8. The unmanned aerial vehicle of claim 1, wherein the one or more airbags are positioned above and below a center of gravity of the frame along the vertical centerline of the frame.

9. The unmanned aerial vehicle of claim 1, wherein the one or more airbags are sealed that prevent air from the one or more airbags to be dissipated upon the impact.

10. The unmanned aerial vehicle of claim 1, wherein the one or more airbags have one or more vents that allow air from the one or more airbags to be dissipated upon the impact.

11. A method comprising:
propelling an unmanned aerial vehicle through the air, the unmanned aerial vehicle having one or more airbags; and
sending an activation signal to an inflation device that inflates the one or more airbags such that the one or more airbags engulf the frame and the propulsion mechanism based upon receipt of the activation signal to deploy the one or more airbags from the storage device prior to an impact of the unmanned aerial vehicle with an object.

12. The method of claim 11, further comprising detecting a condition of a component and sending the activation signal to the inflation device upon the detection of the condition of the component.

13. The method of claim 11, further comprising:
determining that the unmanned aerial vehicle experiences a change in altitude; and
sending the activation signal to the inflation device upon determining that the unmanned aerial vehicle is flying beneath a predetermined altitude.

14. The method of claim 11, further comprising:
determining that the frame experiences a change in acceleration; and
sending the activation signal to the inflation device upon determining that the unmanned aerial vehicle is accelerating at an acceleration in excess of a predetermined acceleration.

15. The method of claim 11, further comprising:
receiving an instruction from a pilot remotely positioned from the unmanned aerial vehicle apparatus; and
sending the activation signal to the inflation device based upon the instruction.

16. A system comprising:
a sensor that determines a condition of a component of an unmanned aerial vehicle, the unmanned aerial vehicle having a storage device that stores one or more airbags and an inflation device; and
a processor that receives a malfunction signal from the sensor indicative of the condition of the component and sends an activation signal to the inflation device to deploy the one or more airbags from the storage device such that the one or more airbags engulf the frame and the propulsion mechanism prior to an impact of the unmanned aerial vehicle with an object.

17. The system of claim 16, wherein the sensor is an altimeter.

18. The system of claim 16, wherein the sensor is an accelerometer.

19. The system of claim 16, wherein the inflation device is a canister of carbon dioxide having an electromechanical activator.

20. The system of claim 16, wherein the one or more airbags have dimensions such that the frame and the propulsion mechanism are engulfed after inflation of the one or more airbags.
